(19) United States
(12) Patent Application Publication
(10) Pub. No.: US 2012/0280056 A1
(43) Pub. Date: Nov. 8, 2012

(54) Illuminated novelty straw

(75) Inventors: Jeffrey D. Schrimmer, Highland Park, IL (US); Arno Schrimmer, Northbrook, IL (US)

(73) Assignee: I PEE HOLDING, LLC., Vernon Hills, IL (US)

(21) Appl. No.: 13/307,685

(22) Filed: Nov. 30, 2011

Related U.S. Application Data
(60) Provisional application No. 61/482,436, filed on May 4, 2011.

(51) Int. Cl. A47G 21/18; F21K 2/06

(52) U.S. Cl. 239/33

(57) ABSTRACT

An illuminated drinking straw includes a drinking straw portion having open upper and lower ends and a light member secured to the drinking straw. The light member is sealed at respective ends to contain a lighting element such that liquid flowing though the drinking straw portion is isolated from contact with the light member.

### CROSS-REFERENCE TO RELATED APPLICATION DATA

This application claims the benefit of priority of Provisional U.S. Patent Application Ser. No. 61/482,436, filed May 4, 2011, the disclosure of which is incorporated herein by reference.

### BACKGROUND OF THE INVENTION

This disclosure pertains to an illuminated straw. More particularly, the disclosure pertains to an illuminatable drinking straw.

Drinking straws provide a way in which a liquid can be consumed from a cup, can, bottle or the like. They have, in some forms, also become novelty items that are used to entertain as well as provide a means to imbibe from a container. For example, straws are available that have different shapes, colors and the like.

Straws are also available that have chemiluminescent ampoules that are contained within the straw that move up and down with the drink being consumed. In such an arrangement, the ampoule is contained within the straw by pinched ends or other elements that prevent the ampoule from being drawn out of the straw and possibly ingested by the user.

Accordingly, there is a need for an illuminated drinking straw that isolates the light member from the drinking portion of the straw. Desirably, such a straw can permit the light member from being separated from the drinking portion of the straw.

### BRIEF SUMMARY

An illuminated drinking straw includes a drinking straw portion having open upper and lower ends and a light member secured to the drinking straw portion. The light member is sealed at respective ends to contain a lighting element such that liquid flowing though the drinking straw portion is isolated from contact with the lighting element.

The lighting element can be a chemiluminescent element, one or more LEDs, a strings of lights, an electro-luminescent wire or the like. The drinking straw portion can be formed from a non-light-transmissive material.

The drinking straw portion and the light member can be formed integral with one another, they can be secured to one another by a weld or by one or more bands or a sleeve encircling the drinking straw portion and the light member. Alternately, an adhesive can be used to secure the drinking straw portion and the light member to one another.

The drinking straw portion and the light member can be affixed to one another so that the drinking straw portion can be separated from the light member without impairing the function or use of the drinking straw portion or the light member.

These and other features and advantages of the present invention will be apparent from the following detailed description, in conjunction with the appended claims.

### BRIEF DESCRIPTION OF DRAWINGS

The benefits and advantages of the present invention will become more readily apparent to those of ordinary skill in the relevant art after reviewing the following detailed description and accompanying drawings, wherein:

FIG. 1 is a front view of an illuminated novelty drinking straw;

FIG. 2A is a cross-sectional view of the straw of FIG. 1 taken along line 2-2 of FIG. 1;

FIG. 2B is cross-sectional view of an alternate straw showing a separable connecting portion;

FIG. 3 is an alternate embodiment of the straw showing a shortened light member;

FIG. 4 is another alternate embodiment of the straw with a sleeve affixing the drinking straw portion and the light member;

FIG. 5 is still another alternate embodiment of the straw with bands affixing the drinking straw portion and the light member;

FIG. 6 is yet another alternate embodiment of the straw showing a light string for providing illumination for the light member; and

FIGS. 7A and 7B are side and cross-sectional views of yet another embodiment of the illuminated drinking straw.

### DETAILED DESCRIPTION

While the present device is susceptible of embodiment in various forms, there is shown in the drawings and will hereinafter be described one or more presently preferred embodiments with the understanding that the present disclosure is to be considered an exemplification of the device and is not intended to limit the disclosure to the specific embodiment or embodiments illustrated.

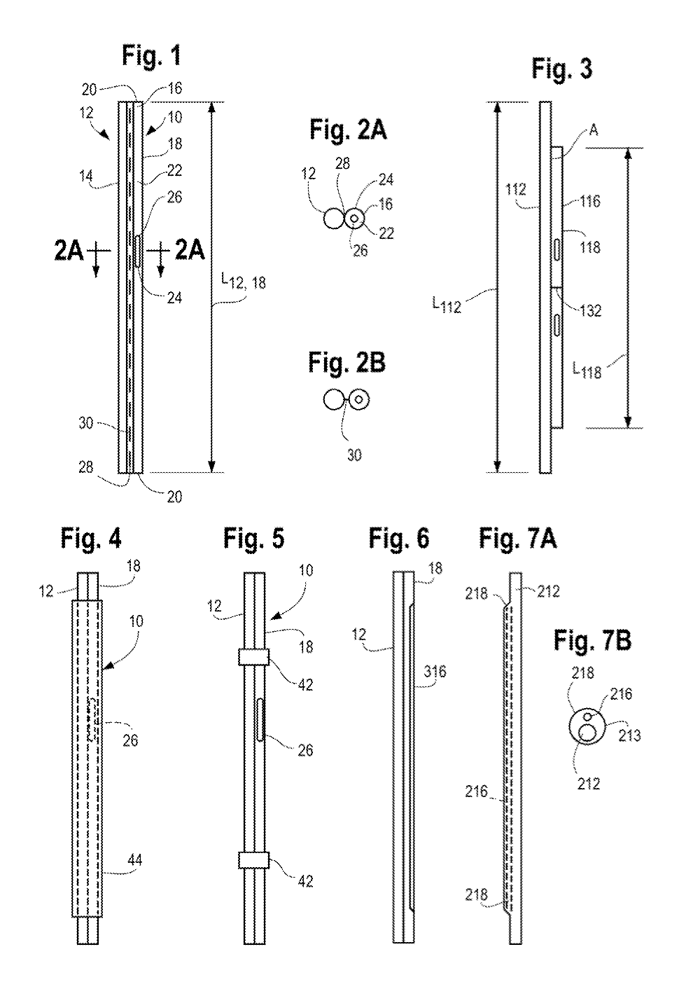

Referring now to the figures and in particular to FIGS. 1 and 2, there is shown an embodiment of a novelty illuminated drinking straw 10. The straw includes a drinking straw portion 12 which is of a conventional straw design and includes a tubular body 14. In one embodiment, light member 13 is mounted to the straw (drinking portion 12) and includes a lighting element 16, such as the illustrated chemiluminescent lighting element. The light member 13 includes a body 18 having sealed ends 20. The chemiluminescent lighting element 16 includes a first chemical 22 present in the body 18 and a frangible vial 24 disposed within sealed body 18. The vial includes a second chemical 26, and is maintained separate from the first chemical 22 by virtue of being within the frangible vial.

The chemicals that, when combined result in the chemiluminescent lighting effect, are well known in the art. For example, they can be of a phthalate-free formulation, such as that disclosed and described in copending U.S. patent application Ser. No. 12/952,008 to Jeffrey D. Schrimmer, which application is commonly assigned with the present application and is incorporated herein by reference. Alternately, the formulation can be of the conventional, phthalate-containing type, also recognized by those skilled in the art.

One exemplary phthalate-free chemiluminescent formulation includes a chemiluminescent component and an activator component. The chemiluminescent component includes an oxalate and a phthalate-free solvent. The activator component includes hydrogen peroxide and a phthalate-free solvent. The phthalate-free chemiluminescent formulation can also include a fluorescer compound. The chemiluminescent component and the activator component are mixed together to produce the chemiluminescent lighting effect.

The oxalate can be, for example, bis(2,4,5-trichlorophenyl-6-carbopentoxyphenyl)oxalate. In such a phthalate-free chemiluminescent formulation, the phthalate-free solvent for the chemiluminescent component and the phthalate-free solvent for the activator component can be the same solvent or different solvents. Alternately, as an example, at least one of the phthalate-free solvent for the chemiluminescent component and the phthalate-free solvent for the activator component is a triethyl citrate. Alternately still, at least one of the phthalate-free solvent for the chemiluminescent component and the phthalate-free solvent for the activator component can be an acetyl tributyl citrate. In still another example, the phthalate-free solvent for the chemiluminescent component can be an acetyl tributyl citrate or the phthalate-free solvent for the activator component can be pure triethyl citrate formed without using an organic titanate.

In any of the above described exemplary phthalate-free chemiluminescent formulations, the fluorescer compound can be included in the chemiluminescent component or the activator component, or both.

Returning now to FIGS. 1 and 2, the chemical 22, 26 components are maintained in the light member body 18, separate and apart from the drinking straw portion 12. It will be appreciated that the ends of the body 18 are sealed (as at 20) to prevent leakage of the chemicals from the body 18. The frangible vial 24 can be formed as a thin-walled glass element that is positioned within the body 18.

In one example, a bridging or connecting portion 28 between the body 18 and the drinking straw portion 12 is formed. The connecting portion 28 can be formed to permit separation of the body 18 from the straw portion 12. In this manner, after a user is finished with the straw portion 12, the light member 13 can be separated from the drinking straw portion 12 and used as a pure novelty device. Likewise, if light member 13 is no longer functioning, the drinking straw portion 12 can be reused as a conventional straw. The separation can be effected by a weakened region, such as a perforated region 30 extending along the connecting portion 28. Alternately, an adhesive (see A, in FIG. 3), such as a food-safe adhesive can be used secure the light member body 18 to the drinking straw portion 12. Of course, the straw 10 can be formed such that the two portions (the drinking straw portion 12 and the light member 13) are integral and not separable from one another.

The two portions, that is the light member body 18 and the drinking straw portion 12 can have about the same length L_{12,18}. Alternately, as illustrated in FIG. 3, the light member body 18 can have a shorter (or a longer) length L₁₁₈ than the length L₁₁₂ of the drinking straw portion. In this embodiment, the drinking straw portion 112 and the light member body 118 can be inseparable or separable as desired.

Optionally, the lighting element 16, 116 can be formed to have more than one color. For example, as seen in FIG. 3, one or more beads or separators 132 can be positioned within the body 118 to separate two or more colors to produce a more interesting or diverse color effect.

In any of the embodiments, the drinking straw portion can be formed from a non-transparent material. For example, plastics (polymers) that do not permit the transmission of light are known. Some of these materials are, by their nature (e.g., inherently) non-light—transmissive or opaque. Other materials are colored with a dye, colorant or the like to prevent the transmission of light. In this manner the liquid traversing through the straw portion cannot be seen even when subjected to light—that is when a light is directed toward the straw.

It will also be appreciated that there are numerous other ways in which the light member body 18 can be affixed or adhered to the drinking straw portion 12. For example, as seen in FIG. 5, bands 42 or as seen in FIG. 4, a sleeve 44 can be positioned over both the drinking straw portion 12 and the light member body 18. Again, the two portions 12, 18 can be formed as a unitary member (molding), or the two portions can be sealed to one another as by an adhesive (see A, in FIG. 3), welding or the like. Optionally, as seen in FIGS. 7A and 7B, the drinking straw portion 212 can be formed as a tube within the body 218 of the light member 213 that carries the lighting element 216.

It will also be appreciated that the illuminated portion can be illuminated by other than chemically activated means. For example, as seen in FIG. 6, LEDs, strings of lights, electro-luminescent wires, as indicated at 316, and the like can be positioned within a sealed chamber of the illuminated portion that is affixed to the drinking portion of the straw.

Although a tubular straw and illuminated member are shown, it will be understood and appreciated by those skilled in the art that the structure and function of the present straw can be readily adapted to other shapes and the like and that such other shapes are within the scope and spirit of the present disclosure.

All patents referred to herein, are incorporated herein by reference, whether or not specifically done so within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present disclosure. It is to be understood that no limitation with respect to the specific embodiments illustrated is intended or should be inferred. The disclosure is intended to cover by the appended claims all such modifications as fall within the scope of the claims.

What is claimed is:

1. An illuminated straw, comprising:
a drinking straw portion having open upper and lower ends;
a chemiluminescent element secured to the drinking straw, the chemiluminescent element being sealed at upper and lower ends, the chemiluminescent element having first and second chemicals therein, separated from one another by an openable seal that, once opened, permits the chemicals to mix within the sealed chemiluminescent element to emit a chemiluminescent light, the chemicals being maintained isolated from the drinking straw portion.

2. The illuminated straw of claim 1 wherein the drinking straw portion and the chemiluminescent element are separable from one another.

3. The illuminated straw of claim 2 including a weakened region between the drinking straw portion and the chemiluminescent element to facilitate separating the drinking straw portion from the chemiluminescent element.

4. The illuminated straw of claim 1 wherein the drinking straw portion and the chemiluminescent element have about an equal length.

5. The illuminated straw of claim 1 wherein the drinking straw portion and the chemiluminescent element have different lengths.

6. The illuminated straw of claim 1 wherein the chemiluminescent element is configured to emit a single color.

7. The illuminated straw of claim 1 wherein the chemiluminescent element is configured to emit more than one color.

8. The illuminated straw of claim 1 wherein the drinking straw portion and the chemiluminescent element are secured to one another by one or more bands encircling the drinking straw portion and the chemiluminescent element.

9. The illuminated straw of claim 1 wherein the drinking straw portion and the chemiluminescent element are secured to one another by a sleeve encircling the drinking straw portion and the chemiluminescent element.

10. The illuminated straw of claim 1 wherein the drinking straw portion and the chemiluminescent element are secured to one another by an adhesive.

11. The illuminated straw of claim 10 wherein adhesive permits separating the drinking straw portion from the chemiluminescent element without impairing the drinking straw portion or the chemiluminescent element.

12. The illuminated straw of claim 1 wherein the drinking straw portion and the chemiluminescent element are secured to one another by a weld.

13. The illuminated straw of claim 1 wherein the drinking straw portion is formed from a non-light-transmissive material.

14. An illuminated straw, comprising:
a drinking straw portion having open upper and lower ends;
a light member secured to the drinking straw, the light member sealed at respective ends to contain a lighting element such that liquid flowing though the drinking straw portion is isolated from contact with the light member.

15. The illuminated straw of claim 14 wherein the light element is a chemiluminescent element.

16. The illuminated straw of claim 14 wherein the light element is an LED, a strings of lights or an electro-luminescent wire.

17. The illuminated straw of claim 14 wherein the drinking straw portion is formed from a non-light-transmissive material.

18. The illuminated straw of claim 14 wherein the drinking straw portion and the light member are secured to one another by one or more bands encircling the drinking straw portion and the light member.

19. The illuminated straw of claim 14 wherein the drinking straw portion and the chemiluminescent element are secured to one another by a sleeve encircling the drinking straw portion and the light member.

20. The illuminated straw of claim 14 wherein the drinking straw portion and the light member are secured to one another by an adhesive.

21. The illuminated straw of claim 14 wherein adhesive permits separating the drinking straw portion from the light member without impairing the drinking straw portion or the light member.

22. The illuminated straw of claim 14 wherein the drinking straw portion and the light member are secured to one another by a weld.
